(19) United States
(12) Patent Application Publication
(10) Pub. No.: US 2009/0192814 A1
(43) Pub. Date: Jul. 30, 2009

(54) Method for updating metadata on write once media containing digital audio and/or video

(75) Inventors: William Pat Price, Rhome, TX (US); Timothy Elliott, Huntington Beach, CA (US)

Correspondence Address: Law Office of Scott C Harris Inc, PO Box 1389, Rancho Santa Fe, CA, 92067, US

(73) Assignee: VIZIO, Irvine, CA (US)

(21) Appl. No.: 12/022,778

(22) Filed: Jan. 30, 2008

(51) Int. Cl. G06Q 30/00; H04N 7/26

(52) U.S. Cl. 705/1; 705/27; 386/124

(57) ABSTRACT

Write once media is used to store many different versions of metadata along with recorded video program. The metadata can be written many times over, for example once for each renter. The metadata can include rental information, or movie trailers, or other information.

### BACKGROUND OF THE INVENTION

The rental of digital content on physical media is a business methodology that has been exploited for many years by large companies such as Block Buster and Netflex. DVD movies rented out by these companies typically include movie trailers and other targeted ads intended to sell products and services. These ads and movie trailers represent a secondary revenue stream to the rental business. One shortcoming of the rental business however is the trailers and ads placed on the DVDs become stale after a period of time. Trailers for movies that will be released to theaters are still seen by customers renting the DVDs long after the theater movies are themselves released to DVDs. The present invention provides a methodology that will allow DVD rental companies to freshen the movie trailers and targeted ads they place on the media. Additionally, this methodology allows the company to more closely target trailers and ads to specific customers based on different demographic data associated with the customer. The present invention gives the rental companies a way to maximize their return on investment and to enhance their revenue stream.

### BRIEF DESCRIPTION OF THE DRAWINGS

Embodiments of the present invention are illustrated by way of example, and not by way of limitation. The following figures and the descriptions both brief and the detailed descriptions of the invention refer to similar elements and in which:

FIG. 1 is a diagram depicting how the metadata is formatted for placement onto optical media for successive rentals.

### DESCRIPTION OF THE INVENTION

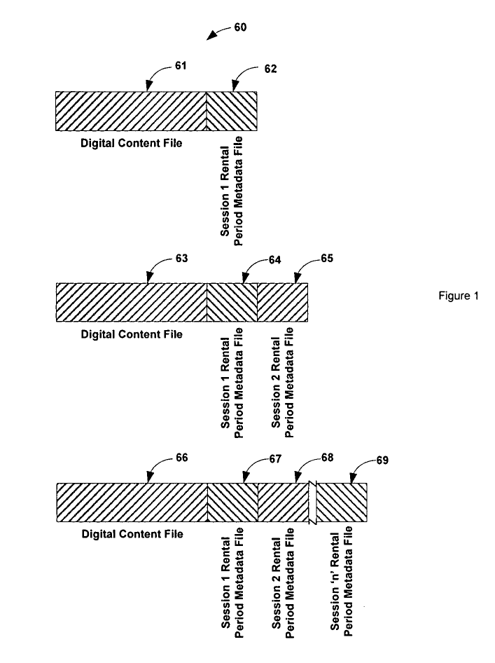

Now referencing FIG. 1, 10 depicts a methodology for changing metadata on optical media. This embodiment addresses a problem where write once optical media which is typically used for rental DVDs. Write-once media typically does not work well in an environment where some of the data needs to be changed many times—here prior to, during or and/or after each rental. Write once media however can have multiple sessions or partitions created one at a time in a serial fashion. In this type of embodiment, several megabytes of space on the media can accommodate hundreds of additional sessions containing small amounts of data. Considering that the space requirements for such data as rental period metadata consume on the order of tens to hundreds of bytes of data, the number of additional sessions that could be written would exceed the usable life span of rental cycles. For example, single pieces of DVD write once media may initially have Digital Content File 11 written on it and Session 1 Rental Period Metadata File 12 written. When the media is returned by a user, Session 2 Rental Period Metadata File 15 can be written as the next session prior to the media being sent to the next customer. This embodiment allows the media distributor to change the rental period rules at will. It also allows for the refreshing of metadata that may contain data other than rental period data. For example, the metadata may contain updated movie trailers and targeted ads that are specifically targeted to the next customer that will receive the media. The metadata can include executable code that operates an application, e.g. an application that is specific to the next renter.

The general structure and techniques, and more specific embodiments which can be used to effect different ways of carrying out the more general goals are described herein.

Although only a few embodiments have been disclosed in detail above, other embodiments are possible and the inventors intend these to be encompassed within this specification. The specification describes specific examples to accomplish a more general goal that may be accomplished in another way. This disclosure is intended to be exemplary, and the claims are intended to cover any modification or alternative which might be predictable to a person having ordinary skill in the art. For example, other kinds of media and players are contemplated, including newer players such as Bluray or HD-DVD.

Also, the inventors intend that only those claims which use the words “means for” are intended to be interpreted under 35 USC 112, sixth paragraph. Moreover, no limitations from the specification are intended to be read into any claims, unless those limitations are expressly included in the claims. The computers described herein may be any kind of computer, either general purpose, or some specific purpose computer such as a workstation. The computer may be an Intel (e.g., Pentium or Core 2 duo) or AMD based computer, running Windows XP or Linux, or may be a Macintosh computer. The computer may also be a handheld computer, such as a PDA, cell phone, or laptop.

The programs may be written in C or Python, or Java, Brew or any other programming language. The programs may be resident on a storage medium, e.g., magnetic or optical, e.g. the computer hard drive, a removable disk or media such as a memory stick or SD media, wired or wireless network based or Bluetooth based Network Attached Storage (NAS), or other removable medium. The programs may also be run over a network, for example, with a server or other machine sending signals to the local machine, which allows the local machine to carry out the operations described herein.

Where a specific numerical value is mentioned herein, it should be considered that the value may be increased or decreased by 20%, while still staying within the teachings of the present application, unless some different range is specifically mentioned. Where a specified logical sense is used, the opposite logical sense is also intended to be encompassed.

What is claimed is:

1. A method of sequentially adding additional data to write once recordable media comprising:
First recording all of digital audio and video content and first metadata information onto write once physical media; and
Second, recording new metadata information onto the same said write once physical media, where said new metadata is different metadata than said first metadata.

2. A method as in claim 1, further comprising renting said physical media to a first customer with said first metadata, and renting said physical media to a second customer with said new metadata.

3. A method as in claim 1, further comprising playing of digital content contained on said physical media.

4. The method of claim 1 where said metadata contains at least one movie trailer.

5. The method of claim 1 where said metadata contains information indicative of a rental period.

6. The method of claim 1 where said metadata contains web browser executable code.

7. The method of claim 6, wherein said metadata includes one of HTML, DHTML, Javascript, or other computer software code.

8. The method of claim 1 where said metadata contains software that allows the user to interact with data contained on said media.

9. The method of claim 1 where said metadata contains software that presents a catalog to said user whereby said user can select items for purchase.

10. A media player, comprising:
A player part, that plays, from write once media, all of digital audio and video content and first metadata information recorded on said write once physical media; and
Said player part reading a most recently-written metadata from said media, from among multiple items of metadata on said media.

11. A player as in claim 10, where said player plays at least one movie trailer from within said metadata.

12. The player of claim 10 where said player obtains information indicative of a rental period from within said metadata.

13. The player of claim 10 where said player executes web browser executable code from within said metadata.

14. The player of claim 10 where said metadata contains software that allows the user to interact with data contained on said media.

15. A method comprising:
recording all of digital audio and video content and first metadata information on to write once physical media;
determining a renter for said write once digital media; and
recording individual metadata information onto said write once physical media, where said individual metadata is specific for said renter.

16. A method as in claim 15, where said metadata contains at least one movie trailer.

17. The system of claim 15 where said metadata contains information indicative of a rental period.

18. The system of claim 15 where said metadata contains software that allows the user to interact with data contained on said media.
